(19) United States
(12) Patent Application Publication
(10) Pub. No.: US 2007/0180046 A1
(43) Pub. Date: Aug. 2, 2007

(54) Method for transporting medical diagnostic information over a wireless communications system

(76) Inventors: Benjamin Cheung, Lake Hiawatha, NJ (US); Gopal N. Kumar, Bridgewater, NJ (US)

Correspondence Address: WILLIAMS, MORGAN & AMERSON, 10333 RICHMOND, SUITE 1100, HOUSTON, TX, 77042, US

(21) Appl. No.: 11/241,252

(22) Filed: Sep. 30, 2005

(51) Int. Cl. G06F 15/16

(52) U.S. Cl. 709/217; 600/407; 370/310

(57) ABSTRACT

A method is provided for controlling data transport in a wireless communications system. The method comprises using a portable diagnostic tool, such as an ultrasound system, to collect information from a patient. The collected information is then transmitted to a remote server of the wireless communications system. The remote server stores the transmitted information and then makes it available for remotely diagnosing the patient.

### BACKGROUND OF THE INVENTION

1. Field of the Invention

This invention relates generally to telecommunications, and, more particularly, to wireless communications.

2. Description of the Related Art

In the field of wireless telecommunications, such as cellular telephony, a system typically includes a plurality of base stations distributed within an area to be serviced by the system. Various mobile devices within the area may then access the system and, thus, other interconnected telecommunications systems, via one or more of the base stations. Typically, a mobile device maintains communications with the system as it passes through an area by communicating with one and then another base station, as the mobile device moves. The process of moving from one base station to another is commonly referred to as a soft handoff and it may occur relatively often if the mobile device is moving rapidly. The mobile device may communicate with the closest base station, the base station with the strongest signal, the base station with a capacity sufficient to accept communications, etc.

Numerous situations arise where health care personnel encounter people in need of emergency medical attention who are not located in a hospital. These situations include natural disasters, ambulance responses, rescue operations, and efforts in third-world countries. A significant aspect of diagnosing patients is administering medical/radiological scans using advanced diagnostic tools. Upon receiving such scans, patients need expert medical interpretation as to their individual conditions. However, the health care personnel aiding patients in these situations typically are nurses, technicians, or relief workers. Therefore, a patient's access to doctors and expert medical diagnoses in such situations becomes difficult.

One common medical diagnostic tool is an ultrasound scan. Today, several manufacturers produce portable ultrasound machines. Health care personnel can use these machines outside the hospital in emergency situations. However, current portable ultrasound machines are built to minimize size and weight. These characteristics limit the machines' capabilities, as compared to their high-end, non-portable counterparts. These limitations result in at least three problems. First, such ultrasound machines can typically only perform limited advanced post-processing functions on raw ultrasound data. Second, the portable machines have lower memory capabilities, preventing them from compiling cinematographic loops. Finally, the portable machines have reduced permanent data storage capabilities. These problems may reduce the likelihood that a patient will receive a complete analysis through portable ultrasound machines.

Another common medical diagnostic tool is a Single Photon Emission Computerized Tomography (SPECT). Doctors use SPECT to diagnose several pathological conditions, including Attention Deficit Hyperactive Disorder, Autism, Unipolar and Bipolar Depression, Schizophrenia, Stroke, and Parkinson's disease. A SPECT machine can be transported into an emergency area via a vehicle, such as a semi-trailer truck. Despite its clear benefits and mobility, the resulting images from such scans should be analyzed by a doctor. In emergency situations, doctors are sometimes not readily available or accessible to provide such analysis. This inaccessibility may reduce the likelihood that a patient will receive an immediate medical diagnosis through mobile SPECT machines.

A third common medical diagnostic tool is an X-Ray. Larger X-Ray systems can scan and digitize images directly into a computer memory or hard drive. Portable X-Ray systems operate similar to their larger immobile counterparts. Health care personnel can use these portable machines outside the hospital in emergency situations. However, these portable units generally have far less power and capabilities than the larger systems. Moreover, a doctor is usually needed to interpret X-Ray data. Thus, using portable X-Ray machines in an emergency situation may result in at least three problems. First, the situation may require experts who are inaccessible to interpret X-Ray images. Second, there may not be enough experts present in an emergency area to adequately diagnose the number of patients. Finally, the reduced capabilities of the portable X-Ray machines prevent the permanent storage and efficient retrieval of images. These problems reduce the likelihood that a patient will receive a complete analysis through portable X-Ray machines.

### SUMMARY OF THE INVENTION

The present invention is directed to overcoming, or at least reducing, the effects of one or more of the problems set forth above.

In one aspect of the instant invention, a method is provided for controlling data transport in a wireless communications system. The method comprises receiving information collected from a patient over the wireless communication system and storing the transmitted information on a remote server. The stored information is then made available for diagnosing the patient.

In another aspect of the instant invention, a method for controlling data transport in a wireless communications system is provided. The method comprises collecting information from a patient, and transmitting the collected information over the wireless communication system to a remote server where it is stored and made available for diagnosing the patient.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a communications system, in accordance with one embodiment of the present invention;

FIG. 2 depicts a block diagram of one embodiment of a base station and a mobile device in the communications system of FIG. 1;

FIG. 3 depicts one embodiment of a flow chart of a method that may be employed to transmit ultrasonic image data to the remotely located server of FIG. 1;

FIG. 4 depicts one embodiment of a flow chart of a method that may be employed to transmit SPECT image data to the remotely located server of FIG. 1; and

FIG. 5 depicts one embodiment of a flow chart of a method that may be employed to transmit SPECT image data to the remotely located server of FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

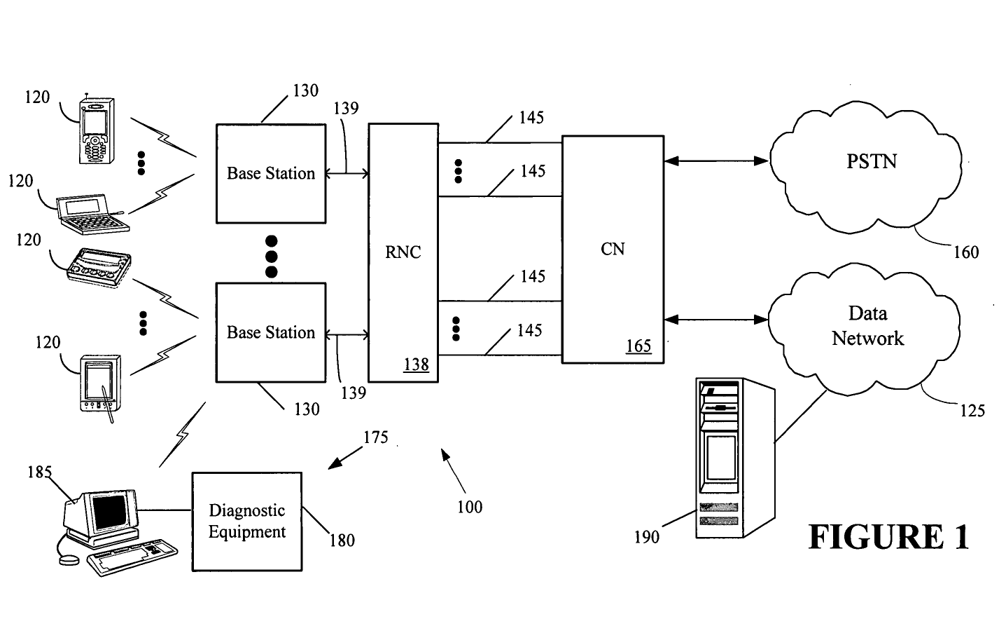

Turning now to the drawings, and specifically referring to FIG. 1, a communications system 100 is illustrated, in accordance with one embodiment of the present invention. For illustrative purposes, the communications system 100 of FIG. 1 is a Code Division Multiple Access (CDMA) system, although it should be understood that the present invention may be applicable to other systems that support data and/or voice communications, such as a Universal Mobile Telephone System (UMTS), or 3^{rd} Generation CDMA systems (like 3GPP2), or the like. The communications system 100 allows one or more mobile devices 120 to communicate with a data network 125, such as the Internet, and/or a Publicly Switched Telephone Network (PSTN) 160 through one or more base stations 130. The mobile device 120 may take the form of any of a variety of devices, including cellular phones, personal digital assistants (PDAs), laptop computers, digital pagers, wireless cards, and any other device capable of accessing the data network 125 and/or the PSTN 160 through the base station 130. In one embodiment of the instant invention, a medical diagnostic device 175 comprised of diagnostic equipment 180 and a controller 185, such as a desktop computer, laptop computer or other intelligent device, may also access the communications system 100 via one or more of the base stations 130. Generally, as discussed in greater detail below, the medical diagnostic device 175 performs certain known procedures on a patient, collects information related to the procedure, and then communicates some or all of the collected information over the communications system 100 and data network 125 to a remote location, such as a server 190, where it may be viewed and/or analyzed by qualified personnel.

In one embodiment, a plurality of the base stations 130 may be coupled to a Radio Network Controller (RNC) 138 by one or more connections 139, such as T1/E1 lines or circuits, ATM circuits, cables, optical digital subscriber lines (DSLs), and the like. Although one RNC 138 is illustrated, those skilled in the art will appreciate that a plurality of RNCs 138 may be utilized to interface with a large number of base stations 130. Generally, the RNC 138 operates to control and coordinate the base stations 130 to which it is connected. The RNC 138 of FIG. 1 generally provides replication, communications, runtime, and system management services. The RNC 138, in the illustrated embodiment handles calling processing functions, such as setting and terminating a call path and is capable of determining a data transmission rate on the forward and/or reverse link for each user 120 and for each sector supported by each of the base stations 130.

The RNC 138 is also coupled to a Core Network (CN) 165 via a connection 145, which may take on any of a variety of forms, such as T1/E1 lines or circuits, ATM circuits, cables, optical digital subscriber lines (DSLs), and the like. Generally the CN 165 operates as an interface to a data network 125 and/or to the PSTN 160. The CN 165 performs a variety of functions and operations, such as user authentication, however, a detailed description of the structure and operation of the CN 165 is not necessary to an understanding and appreciation of the instant invention. Accordingly, to avoid unnecessarily obfuscating the instant invention, further details of the CN 165 are not presented herein.

The data network 125 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 125 may also include other types of packet-based data networks in further embodiments. Examples of such other packet-based data networks include Asynchronous Transfer Mode (ATM), Frame Relay networks, and the like.

As utilized herein, a “data network” may refer to one or more communication networks, channels, links, or paths, and systems or devices (such as routers) used to route data over such networks, channels, links, or paths.

Thus, those skilled in the art will appreciate that the communications system 100 facilitates communications between the mobile devices 120 and the data network 125 and/or the PSTN 160. It should be understood, however, that the configuration of the communications system 100 of FIG. 1 is exemplary in nature, and that fewer or additional components may be employed in other embodiments of the communications system 100 without departing from the spirit and scope of the instant invention.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

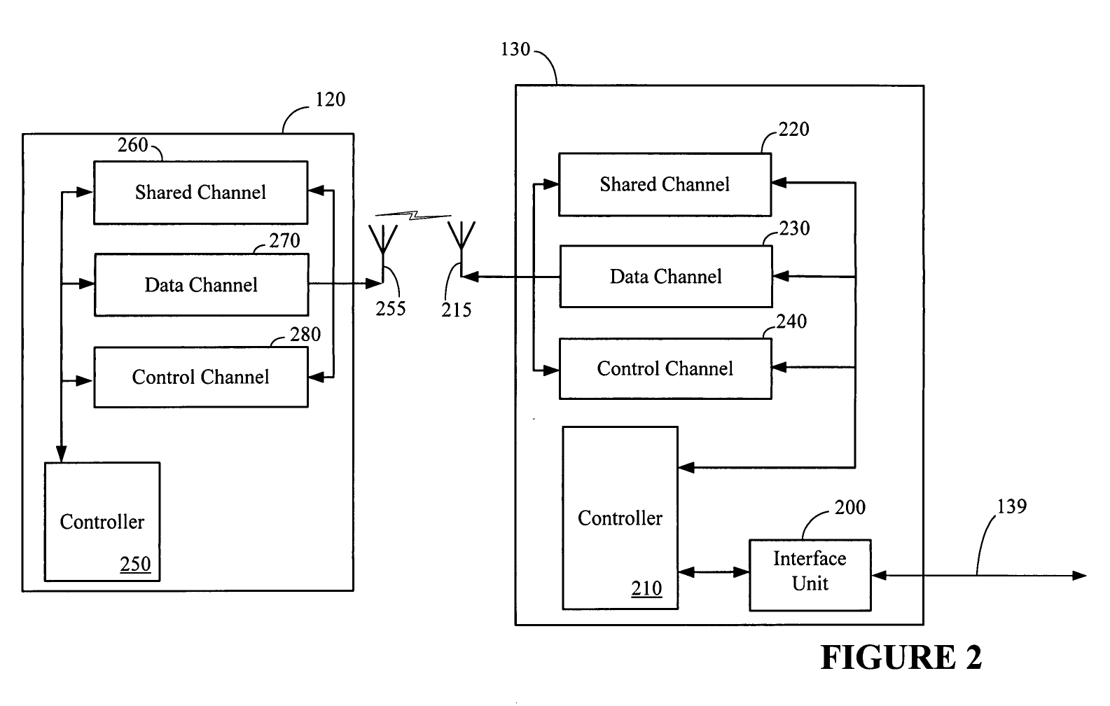

Referring now to FIG. 2, a block diagram of one embodiment of a functional structure associated with an exemplary base station 130 and mobile device 120 is shown. It will be appreciated that the medical diagnostic device 175 employs functional structure that may be substantially identical to the functional structure associated with the mobile device 120. The base station 130 includes an interface unit 200, a controller 210, an antenna 215 and a plurality of channels, such as a shared channel 220, a data channel 230, a control channel 240, and the like. The interface unit 200, in the illustrated embodiment, controls the flow of information between the base station 130 and the RNC 138 (see FIG. 1). The controller 210 generally operates to control both the transmission and reception of data and control signals over the antenna 215 and the plurality of channels 220, 230, 240 and to communicate at least portions of the received information to the RNC 138 via the interface unit 200.

The mobile device 120 shares certain functional attributes with the base station 130. For example, the mobile device 120 includes a controller 250, an antenna 255 and a plurality of channels, such as a shared channel 260, a data channel 270, a control channel 280, and the like. The controller 250 generally operates to control both the transmission and reception of data and control signals over the antenna 255 and the plurality of channels 260, 270, 280.

Normally, the channels 260, 270, 280 in the mobile device 120 communicate with the corresponding channels 220, 230, 240 in the base station 130. Under the operation of the controllers 210, 250, the channels 220, 260; 230, 270; 240, 280 are used to effect a controlled scheduling for communications from the mobile device 120 to the base station 130.

Typically, operation of the channels 260, 270, 280 in the mobile device 120 and the corresponding channels 220, 230, 240 in the base station 130 have been time slot operated. For example, data to be delivered over the data network 125 may be packetized and delivered over both the forward and reverse links so that data may be received from and sent to the diagnostic equipment 180.

In one embodiment of the instant invention, the diagnostic equipment 180 takes the form of a portable ultrasound machine that is capable of communicating with a 3rd Generation Wireless system. In the illustrated embodiment, the portable ultrasound machine is capable of carrying a 3rd Generation data call. In one embodiment of the instant invention, the portable ultrasound machine would be able of transmit over the airwaves using either 3G1X 3G CDMA or UMTS 3G (Universal Mobile Telecommunication Systems). The Portable Ultrasound machine is used to scan a patient, and the resultant diagnostic data may then be sent across the 3G air interface. The diagnostic data is ultimately delivered via the internet to the server 190 where it may be stored and subsequently reviewed by a doctor, such as a radiologist or physician.

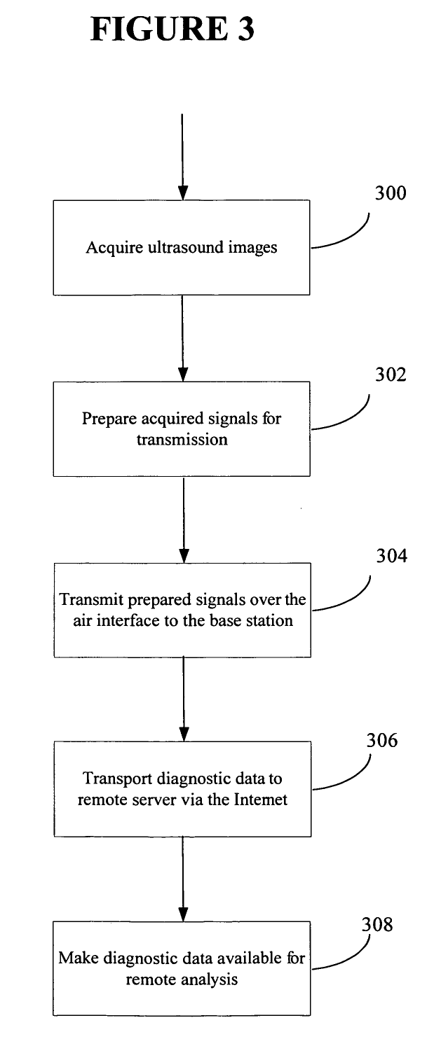

Turning now to FIG. 3, a flow chart of one embodiment of a method that may be employed to convey medical diagnostic data to the remotely located server 190 is shown. The process begins at block 300 with a technician operating the portable ultrasound machine in the field by, for example, applying transducing gel, and using a portable ultrasound transducer to acquire images from the patient. The ultrasound machine may be comprised of any of a variety of commercially available devices, but in one embodiment of the instant invention, it is anticipated that the portable ultrasound system will include a 16 channel element transducer. At block 302, the acquired signals are modulated, interleaved, coded, packetized, and secured in preparation of transmitting the diagnostic data.

At least four significant issues associated with transporting the diagnostic data are addressed by the instant invention: security, bandwidth, latency and scalability. Once the information is packetized, the packets can be given coding and standard security policies can be employed. 3G wireless networks are being designed to perform financial transactions, and thus mechanisms to employ security have been included. Substantially similar security mechanisms may be employed to ensure the security of the diagnostic data. Additionally, wireless network operators desire to ensure privacy of their end users (terminal phone users), and thus security mechanisms are employed to provide this privacy. These same principles may be used to maintain privacy in the instant invention. Sufficient bandwidth is a significant issue in the instant invention, as well. Adequate bandwidth is generally required in the instant invention to ensure the proper operation of streaming video to be sent from the portable ultrasound machine to the Internet and then to the receiving doctor. Adequate bandwidth can be insured by Quality of Service and Grade of Service mechanism that have been developed to provide a data pipe adequate for an ultrasound transmission for a particular length of time. Latency is a concern when vascular applications are used. The portable ultrasound machine utilizes colors to show the movement of blood platelets moving towards and away from the transducer. This information is used to ultimately diagnose the patient. In vascular applications, latency is important as the computational flow of blood is used to assess the patient's situation. Latency may be reduced to a level adequate for operation of the instant invention by the use of a cinematographic memory looping system, wireless data scheduling algorithms and quality of service designations used by cellular telephone service providers. Scalability is important from the standpoint of broad dissemination of multiple portable ultrasound systems all working simultaneously. Furthermore, in disaster management situations, the wireless 3G networks are often oversubscribed, and unable to provide service. Mechanisms may be employed within the 3G networks to give these diagnostic data calls the highest priority possible.

At block 304, the prepared signals are transmitted over the air interface to one of the 3G base stations 130. At block 306, the base station 130 then transports the diagnostic data to the Internet and then to the server 190. At block 308, the server 190 then makes the diagnostic data available to the doctor. The doctor may then apply his/her expertise from a remote location, and direct the technician regarding how and where to scan further. Such a system could conceivably be used to diagnose a number of physical or vascular based maladies ranging from broken bones to myocardial infarctions. Exemplary ultrasound applications include: (1) power doppler for vessel architecture, non-directional flow analysis and “glass body” rendering; (2) real-time biopsy assistance; (3) volume contrast imaging for structural scanning; (4) compound resolution imaging for defining organ borders and tissue differentiation; (5) coded excitation for pediatric and obstetric applications; (6) color spectral doppler for portal venous investigation and vascular interrogation; and the like. Most of these applications can be used in emergency relief and in remote regions, where primary care physicians can not reach easily.

In an alternative embodiment of the instant invention, the diagnostic equipment 180 takes the form of a Single Photon Emission Computerized Tomography (SPECT) imaging tool that is capable of communicating with a 3rd Generation Wireless system. In the illustrated embodiment, the SPECT imaging tool is capable of carrying a 3rd Generation data call. In one embodiment of the instant invention, the SPECT imaging tool would be capable of transmitting over the airwaves using either 3G CDMA or UMTS 3G (Universal Mobile Telecommunication Systems). Generally, the SPECT imaging tool may convey scans to the remotely located server 190 for remote radiological applications. SPECT is a diagnostic medical imaging modality derived from Positron Emission Tomography (or PET). Both these technologies utilize blood flow in the brain. The patient is injected with a Radioactive isotope. Areas of increased blood flow take up more of the Radioactive tracer than areas of less blood flow. Since blood flow in the brain is directly related to brain activity, areas in the brain are related in their demand for blood flow, which can be imaged with this specific nuclear test.

The basis of the brain image comes from the temporary uptake of radioactive particles; from the blood into the brain tissue. The radioactive particles are “tagged” to a drug that flows into the brain. These particles come from the radioactive decay of the element Technetium (TC99). A SPECT Gamma camera system detects emissions from these particles as they decay and reconstructs an image of the brain at work. Nuclear medicine and Diagnostic medical imaging devices based on nuclear medicine, have advanced greatly over the past 30 years, and have improved both the quality and accuracy of these systems. Also, the understanding and refinement of radiopharmaceuticals has developed.

The challenges for transporting diagnostic medical images over the airwaves are numerous. The primary technical challenges are: (1) Reliability (2) Security (3) Bandwidth (4) Latency and (5) Scalability.

In a 3^{rd} generation mobile phone systems, the minimum requirements for a reliable connection would be similar as for a “Quality of Service” (3G term) classification of “Streaming.” This refers to a video that is being played back, for example, on a video tape recorder. This same level of quality and reliability are useful within a remote SPECT system. A dropped call, or RF fade, could momentarily reduce the effectiveness of a remote diagnosis, until the call recovers.

The 2^{nd} technical aspect is security. Once the information is packetized, the packets can be given coding and standard security policies can be employed. 3G wireless networks will also be able to perform financial transactions, and thus have mechanisms to employ security. Additionally, wireless network operators want to ensure privacy of their end users (terminal phone users), thus security mechanisms are employed to provide this. Lastly, higher layer protocols (at the session and transport layer) can employ security algorithms to further insure secure transfer of data.

The third technical aspect is Bandwidth. Adequate bandwidth must be ensured in the system to allow for a streaming video to be sent from the portable SPECT imaging tool to the Internet and then to the receiving radiologist or physician. Adequate bandwidth can be insured by Quality of Service and Grade of Service mechanisms that have and are being developed to provide a data pipe adequate for a SPECT transmission for a particular length of time.

Next, latency is a concern when vascular applications are used. The portable SPECT imaging tool utilizes colors to show movement of blood platelets towards and away from the transducer. This information is used to ultimately diagnose the patient. In vascular applications, latency is important because the computational flow of blood is used to assess the patient's situation.

Scalability is a factor from the standpoint of broad dissemination of multiple portable SPECT imaging tools all working simultaneously. Furthermore, in disaster management situations, often the wireless 3G networks are oversubscribed, and unable to provide service. It is useful to employ mechanisms within the 3G networks to give these calls a high priority.

Generally, a portable SPECT imaging tool that is integrated with a 3G network wireless system would allow diagnostic images to be transferred to a physician or radiologist who could then interpret the images. Portability of the SPECT imaging tool may be effected by any of a wide variety of implementations, such as locating the SPECT imaging tool inside of a tractor-trailer (semi-rig). Generally, a technician would inject the patient with a radioactive tracer, and use the SPECT imaging tool to acquire images of the patient. The acquired signals would then be modulated, interleaved, coded, packetized, secured, and finally transmitted over the air interface to the 3G base station 130. The Base Station 130 would then transport the data to the Internet and finally to the Radiologist or Doctor. The Radiologist could then apply their expertise from a remote location.

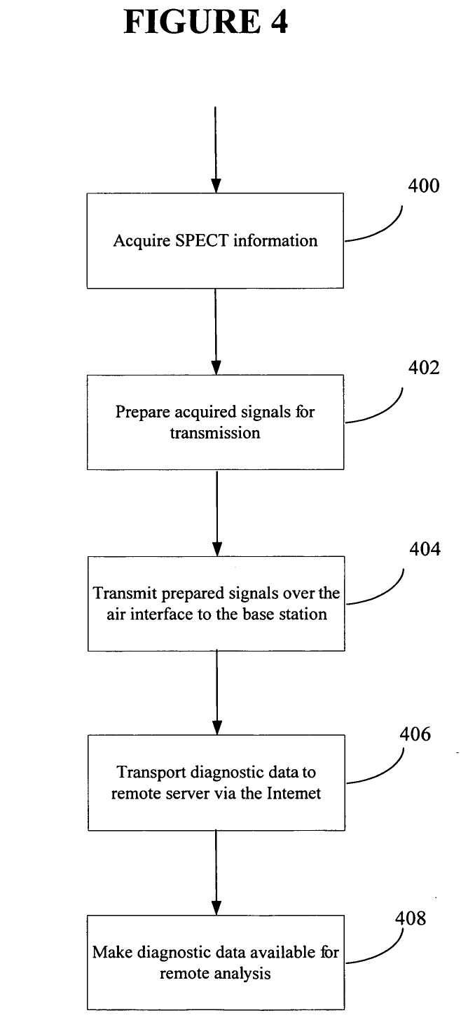

Turning now to FIG. 4, a flow chart of one embodiment of a method that may be employed to transmit SPECT image data to the remotely located server 190 is shown. The process begins at block 400 with a technician operating the SPECT imaging tool in the field by, for example, using a transducer to acquire images from the patient. The SPECT imaging tool may be comprised of any of a variety of commercially available devices. At block 402, the acquired signals are modulated, interleaved, coded, packetized, and secured in preparation of transmitting the diagnostic data.

At block 404, the prepared signals are transmitted over the air interface to one of the 3G base stations 130. At block 406, the base station 130 then transports the diagnostic data to the Internet and then to the server 190. At block 408, the server 190 then makes the diagnostic data available to the doctor. The doctor may then apply his/her expertise from a remote location, and direct the technician regarding how and where to scan further, or give a prognosis, or assessment of the patient. Such a system could conceivably be used to diagnose a number of pathological conditions. For example, the SPECT imaging tool could be used to diagnose: Attention Deficit Hyperactive Disorder, Developmental disorder; Autism, Aspergers syndrome, Unipolar and Bipolar Depression, Panic, Obsessive-Compulsive Disorder, Epilepsy and Non-epileptic seizure equivalents, Post traumatic stress disorder, Migraine and common headaches, Schizophrenia, Dementia; and memory loss, Stroke, Multiple Sclerosis, Parkinson's Disease.

In an alternative embodiment of the instant invention, the diagnostic equipment 180 takes the form of a portable X-ray system that is capable of communicating with a 3^{rd} Generation Wireless system. In the illustrated embodiment, the portable X-ray system is capable of carrying a 3rd Generation data call. In one embodiment of the instant invention, the portable X-ray system would be able of transmit over the airwaves using either 3^{rd} Generation CDMA or UMTS 3G (Universal Mobile Telecommunication Systems). Generally, the portable X-ray system may convey scans to the remotely located server 190 for remote radiological applications.

X-Ray machines are used for a broad range of applications. As a diagnostic medical imaging modality in the field of Medicine, it is used to look for problems related to the bone. In security situations, X-Ray machines are used to scan baggage, cargo and items to look for potentially hazardous items that have the potential to endanger others. X-Ray systems are used in manufacturing for quality assurance, in scientific research to analyze materials, and a host of other applications. Most applications of X-ray systems are based on their ability to pass through matter. This ability varies with different substances and substance density. The penetrating power of X-rays also depends on their energy. The more penetrating X-rays known as hard X-Rays are of higher frequency and are more energetic. Less energetic X-rays, called “Soft X-rays” have less penetrating power. X-Rays that have passed through a body provide a visual image of its interior structure when they strike a photographic plate or sensor system. The darkness of shadows produced depends on the opacity, density, physical orientation, and structure of the target being scanned. Photographs made with X-Rays are known as Radiographs or Skiagraphs. Radiography has applications in both medicine and industry, where it is valuable for diagnosis and nondestructive testing of products for defects.

Wilhelm Roentgen discovered X-Rays in 1895. For the first time, physicians had a non-surgical tool to see inside the body. The medical and scientific uses of X-rays spread quickly throughout Europe and the United States. Numerous improvements have been made to X-ray scanning, the most notable of which is an entirely different imaging modality called CAT (Computerized Axial Tomography), which uses a computer to assemble a set of X-ray scans to produce an composite image of the body. X-ray systems continue to be used and the resultant scans are commonly digitized. CAT (or CT) scans are generally used on large cross sections of the body, while X-Ray systems are used for more local scans, for example, dentistry. X-Ray systems can now be scanned and digitized directly into a computer for viewing by humans. The images so digitized can be stored in the computer memory or a hard drive (digital storage device). Portable X-Ray systems operate on the same principles as larger immobile systems. They vary in power and capability.

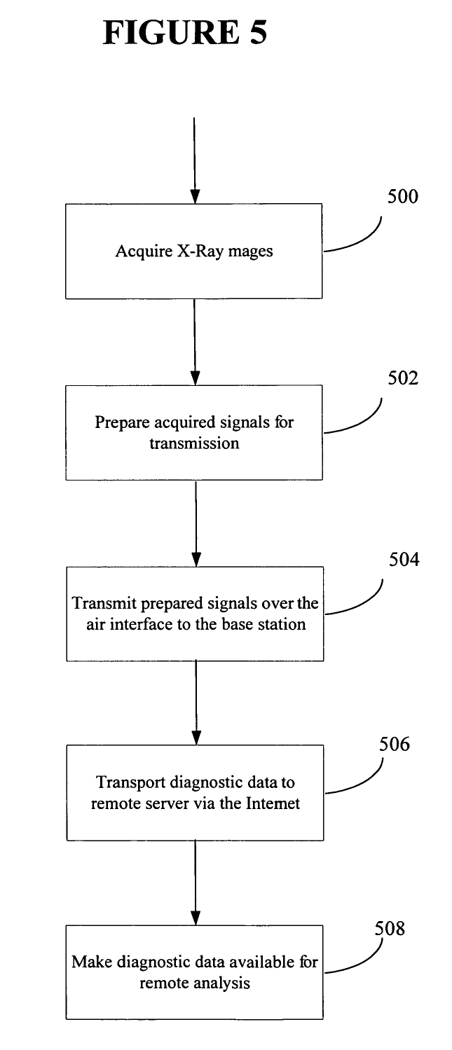

Turning now to FIG. 5, a flow chart of one embodiment of a method that may be employed to transmit X-ray data to the remotely located server 190 is shown. The process begins at block 500 with a technician operating the portable X-ray system in the field by, for example, using a transducer to acquire images from the patient. The portable X-ray system may be comprised of any of a variety of commercially available devices. At block 502, the acquired signals are modulated, interleaved, coded, packetized, and secured in preparation of transmitting the diagnostic data.

At block 504, the prepared signals are transmitted over the air interface to one of the 3G base stations 130. At block 506, the base station 130 then transports the diagnostic data to the Internet and then to the server 190. At block 508, the server 190 then makes the diagnostic data available to the doctor. The doctor may then apply his/her expertise from a remote location, and direct the technician regarding how and where to scan further. Such a system could conceivably be used to diagnose a number of medical conditions.

In an alternative embodiment of the instant invention, the diagnostic equipment 180 takes the form of a portable ultrasound machine that is capable of collecting data that may be used to form cine-loops of ultrasound scans, and then communicating with a 3rd Generation Wireless system. In the illustrated embodiment, the portable ultrasound machine is capable of carrying a 3rd Generation data call. In one embodiment of the instant invention, the portable ultrasound machine would be able of transmit over the airwaves using either 3^{rd} Generation CDMA or UMTS 3G (Universal Mobile Telecommunication Systems). The Portable Ultrasound machine is used to scan a patient, and send the data that may be used to form a cine-loop across the 3G air interface. The cine-loop data is ultimately delivered via the internet to the server 190 where it may be stored and subsequently reviewed by a doctor, such as a radiologist or physician.

Typically, portable ultrasound systems try to minimize form size. This reduced size limits the amount of memory on the portable ultrasound unit. These units are typically handheld. The reduced memory limits the functional usefulness of portable ultrasound systems. Data acquired from the patient, is captured in real-time. The information streaming in from the transducer is captured and displayed as it is being scanned. The portable ultrasound machines are produced and used for remote locations in first world countries, military battlefield conditions, for disaster relief, and for low-cost regions in the world. Currently, a number of portable ultrasound manufacturers exist. In one embodiment of the instant invention, rather than store the cine-loop locally within the limited memory of the portable ultrasound system, the instant invention utilizes a 3^{rd} Generation Wireless system that is integrated with the portable ultrasound system to send the cine-loop to the remote server 190.

Once the scan data has been stored in the remote server 190, it can be forwarded to a radiologist or physician. The doctor could then replay the scans in a “cine-loop.” The term “cine-loop” is an ultrasound equipment manufacturer industry standard term. It is short for cinematographic loop. The cine-loop refers to the capability by high-end ultrasound machines to be able to replay scans just acquired by the system. This is highly useful for sonographers, physicians, and ultrasound technicians as it allows someone to see blood flows as they were in real-time when they occurred. It also allows the physicians or technician to “freeze” a scan sequence at a critical point. It gives them the opportunity to identify irregular blood flow associated with numerous pathological conditions of the arteries. The remote physician could contact the on-hand technician and instruct them how to proceed or give them advice. Similarly, the technician on-site could also request for the cine-loop to be replayed on the screen of the hand-held portable Ultrasound machine. Cine-loop playback from the server 190 could also allow a physician to use a larger screen instead of the relatively small screen of the handheld portable ultrasound system, enhancing the physician's capability to identify something amiss with the health of the patient.

This server 190 may be located in a fixed location. In some embodiments of the instant invention, the server 190 may take the form of a desktop or laptop computer. The server 190 may be simply identified by an Internet Protocol (IP) address. The server 190 would have a large storage capability, such as hard drives capable of storing a huge quantity of ultrasound scan data. Additionally, the server 190 should be able to retrieve the scan data from either a physician or the portable ultrasound system. Also the server 190 should be able to handle requests from multiple users of the same scan at the same time. In some embodiments of the instant invention, it would be useful for the server 90 to be able to handle synchronized requests, where the field technician and the physician are able to see the cine-loop simultaneously. However, the server 190 should also be able to handle different and individual requests as well. A cine-loop (short for cinematographic loop) can be moved backwards in time with a controlling computer device, such as a trackball device. The server 190 would not necessarily have to be dedicated to just storage and replay of ultrasound information. In some embodiments of the instant invention, it may be useful to use a plurality of hard drive servers to distribute the processing needs to handle a number of portable ultrasound machines in the field at the same time. The stored information (ultrasound scan) could then be accessed by a sonographer or doctor from a remote location to where the scans were taken. The doctor could then apply his/her expertise from a remote location, and direct the technician of how and where to scan further. Such a system could conceivably be used to diagnose a number of physical maladies ranging from broken bones to myocardial infarctions. The cine-loop could also be sent back or streamed to the portable ultrasound unit (and hence technician) via the same 3G-air interface.

For example, hypothesize that a 5-minute scan were performed on a patient in the Tsunami disaster of December 2004 in the Indonesia. The relief worker or rescue worker would scan the patient with a handheld portable ultrasound scanner. The ultrasound scan, has built into the RF circuitry necessary to send the scan, being taken in real-time to a 3G Base Station. The scan is then stored on the server 190. The server 190 continues to store the scan information for as long as the technician continues to perform the scan. In this case, the scan time was 5 minutes. At the end of those 5 minutes, suppose the technician pushes a button on the portable ultrasound scanner that requests for the system to be put into cine-mode. The portable ultrasound scanner would then request back the scanned information that it has stored. The technician would use a trackball or other like input device (or depress another key on the portable ultrasound scanner), indicating that he wished to go back in time. The server 190 would relay the scan via the 3G-air interface (3G cellular wireless network) back to the Portable handheld ultrasound scanner. Replaying back in time the cine-loop. The scan would go back in time, starting at when the scan ended at 5 minutes all the way (potentially) back down to 0 minutes. The technician would be able to stop the replay perhaps at 4 minutes when there might have been an odd vascular back flow that caught his attention. He would be able to pause and move forward or backward from that 4-minute point. Simultaneously, a physician could access that same 5 minute cine-loop and analyze it from a computer in a hospital. Conceivably, the amount of ultrasound scans (time) that can be stored is limited only by the memory size of the server 190. That is, how long the cine-loop can be is only limited by the storage capacity of the server 190. The doctor could also trackball back in time, viewing the stored cine-loop and looking for anomalies with the patient either independent or synchronized with the technician, thus increasing the reliability of a medical accurate assessment.

In an alternative embodiment of the instant invention, the ultrasound scan obtained by the field technician could be processed by the server 190 (or specially designed circuit pack—hardware board) to ascertain doppler flow information. Once the Doppler flow information has been ascertained, the information can be sent to a radiologist or physician. The doctor could then analyze the image(s), and contact the on-hand technician instructing them how to proceed. The color flow (doppler) information would then be sent back to the portable ultrasound system for display on the screen.

The server 190 could perform the following tasks:

(1) Power Doppler—The remote processor would process the raw ultrasound data using power doppler as one of its functions. Power doppler is an ultrasound technique that is five times more sensitive than regular color doppler. Power doppler can produce diagnostic medical images of a patient that are difficult or impossible to obtain using standard color doppler. Power doppler is commonly used to evaluate blood flow through vessels within solid organs. Blood flow in individual blood vessels is most commonly evaluated by combining color doppler with duplex doppler. Together color doppler and duplex doppler are able to provide better information on the direction and speed of blood flow than when used separately.

(2) Color Doppler—color doppler uses standard ultrasound methods to produce a picture of a blood vessel. Christian Andreas Doppler (Salzburg, Austria b. 1674) discovered the doppler effect, first explained in 1842. The server 190 may take the form of a computer that remotely converts the raw ultrasound information into doppler movement using colors that could then be overlaid on top of the original image of the blood vessel. Color doppler is used to code for the speed and direction of blood flow through the vessel with respect to the transducer element.

(3) Duplex Doppler—This type of ultrasound technique uses standard ultrasound methods to produce a picture of a blood vessel and its surrounding organs. The server 190 may convert the doppler sounds into a graph that provides information about the speed and direction of blood flow through the blood vessel being evaluated.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs), digital video disks (DVDs) or industrial hard-drive arrays (RAID arrays). Instructions that make up the various software layers, routines, or modules in the various systems may be stored in respective storage devices. The instructions when executed by the control units cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

We claim:

1. A method for controlling data transport in a wireless communications system, comprising:
receiving information collected from a patient over the wireless communication system;
storing the transmitted information on a remote server; and
making the stored information available for diagnosing the patient.

2. A method, as set forth in claim 1, wherein the information collected from the patient further comprises ultrasound information.

3. A method, as set forth in claim 2, further comprising processing the information stored on the remote server.

4. A method, as set forth in claim 3, wherein processing the information stored on the remote server further comprises processing the stored information into a cine-loop.

5. A method, as set forth in claim 3, wherein processing the information stored on the remote server further comprises processing the stored information to ascertain doppler flow information

6. A method, as set forth in claim 1, wherein the information collected from the patient further comprises Single Photon Emission Computerized Tomography information.

7. A method, as set forth in claim 1, wherein the information collected from the patient further comprises X-ray information from the patient.

8. A method, as set forth in claim 1, wherein receiving information collected from the patient over the wireless communication system further comprises receiving information collected from the patient over a third generation wireless system.

9. A method, as set forth in claim 8, wherein receiving information collected from the patient over the third generation wireless system further comprises receiving information collected from the patient over the third generation wireless system using 3^{rd} Generation CDMA.

10. A method, as set forth in claim 8, wherein receiving information collected from the patient over the third generation wireless system further comprises receiving information collected from the patient over the third generation wireless system using UMTS 3G.

11. A method for controlling data transport in a wireless communications system, comprising:
collecting information from a patient;
transmitting the collected information over the wireless communication system to a remote server where it is stored and made available for diagnosing the patient.

12. A method, as set forth in claim 11, wherein collecting information from the patient further comprises collecting ultrasound information from the patient.

13. A method, as set forth in claim 12, further comprising processing the information stored on the remote server.

14. A method, as set forth in claim 13, wherein processing the information stored on the remote server further comprises processing the stored information into a cine-loop.

15. A method, as set forth in claim 13, wherein processing the information stored on the remote server further comprises processing the stored information to ascertain doppler flow information

16. A method, as set forth in claim 11, wherein collecting information from the patient further comprises collecting Single Photon Emission Computerized Tomography information from the patient.

17. A method, as set forth in claim 11, wherein collecting information from the patient further comprises collecting X-ray information from the patient.

18. A method, as set forth in claim 11, wherein transmitting the collected information over the wireless communication system to a remote server further comprises transmitting the collected information over a third generation wireless system.

19. A method, as set forth in claim 18, wherein transmitting the collected information over a third generation wireless system further comprises transmitting the collected information over the third generation wireless system using 3^{rd} Generation CDMA.

20. A method, as set forth in claim 18, wherein transmitting the collected information over a third generation wireless system further comprises transmitting the collected information over the third generation wireless system using UMTS 3G.
